(19) United States
(12) Patent Application Publication
(10) Pub. No.: US 2005/0035518 A1
(43) Pub. Date: Feb. 17, 2005

(54) Workpiece clamp with two alternately applicable compression rings

(76) Inventor: Beat Ammann, Chiasso (CH)

Correspondence Address: YOUNG & THOMPSON, 745 SOUTH 23RD STREET, 2ND FLOOR, ARLINGTON, VA, 22202, US

(21) Appl. No.: 10/491,241

(22) PCT Filed: Feb. 4, 2003
(86) PCT No.: PCT/IB03/00364

(30) Foreign Application Priority Data
Feb. 22, 2002 (CH) 0318/02

(51) Int. Cl. B25B 1/06; B25B 1/16

(52) U.S. Cl. 269/227

(57) ABSTRACT

A workpiece clamp (1) for a machine tool that drills at high speeds is provided with two compression rings (2, 3) with holes (2f, 3f) of different diameters for the passage of drilling tools of different diameters. The rings are mounted on the clamp, symmetrically and on opposite sides of the drilling axis (Z-Z) in such a way that they are able to rotate about the horizontal axes of two pinions (4, 5) meshing with a rack (6) that is moved in both directions relative to a central point (P) through a stroke (C) by a double-acting pneumatic piston (7). The form, dimensions and positions of the rings are such that, in response to the rotation of their respective pinions only one, alternatively, of the said rings is placed in the working position, with the axis of its hole coincident with the drilling axis (Z-Z); the other ring being laterally displaced where it does not interfere with the drilling axis (Z-Z).

The present invention relates to machine tools that use spindles for drilling at high speeds.

More particularly, it relates to spindles themselves, and more specifically the workpiece clamps which they usually have, which fulfil the function of pressing down on the workpiece being drilled via a compression ring or “foot”, to keep it still and compressed against other workpieces beneath it to obtain precise and exactly aligned drilling, and ensure that chips cannot get between the adjacent faces of several superimposed workpieces.

To perform the said function, the said compression ring has a hole whose axis coincides during the machining action with the drilling axis, in other words with the axis of the tool for doing the drilling.

Particularly when drilling several superimposed sheets of synthetic material, such as those that make up “multilayer” printed circuit boards, it is necessary for the said hole of the compression ring to have as small a diameter as possible in order to improve the efficiency of the chip removal system and ensure that the elastic recovery of the material through it cannot be a source of inaccuracies in the machining or allow the abovementioned intrusion of chips between the superimposed layers.

It is for this kind of reason that, when holes of different diameters are to be drilled in sequence in the same workpiece, compression rings with holes of different diameters are used, being changed as required during machining.

Changing the rings at present requires manual disassembly and reassembly of the rings, fetching them from a magazine which may be separate from the machine tool or provided in a suitable position on the machine tool itself. This operation wastes a lot of time and, even when using semiautomatic devices for changing the rings, it brings about an appreciable rise in the production costs.

Since it is usually sufficient to have two compression rings with different diameter holes, especially when drilling printed circuit boards, it seemed to the inventor of the present innovation that the downtimes and constructional complications described above could be eliminated by providing a workpiece clamp on which two compression rings are mounted, with mechanical means for positioning them alternately, in accordance with the machine tool programme, in the working position, by a simple, fast operation.

To this end the inventor has provided a solution whereby a rack, moved by a double-acting pneumatic piston, causes by its movement a simultaneous rotation of two pinions integral with the two compression rings, the effect being to position each alternately in its working position, and the other in a position where it cannot interfere with the tool while the tool is working.

To this end he devised the subject of the present invention, which is a workpiece clamp as described in the appended claim 1.

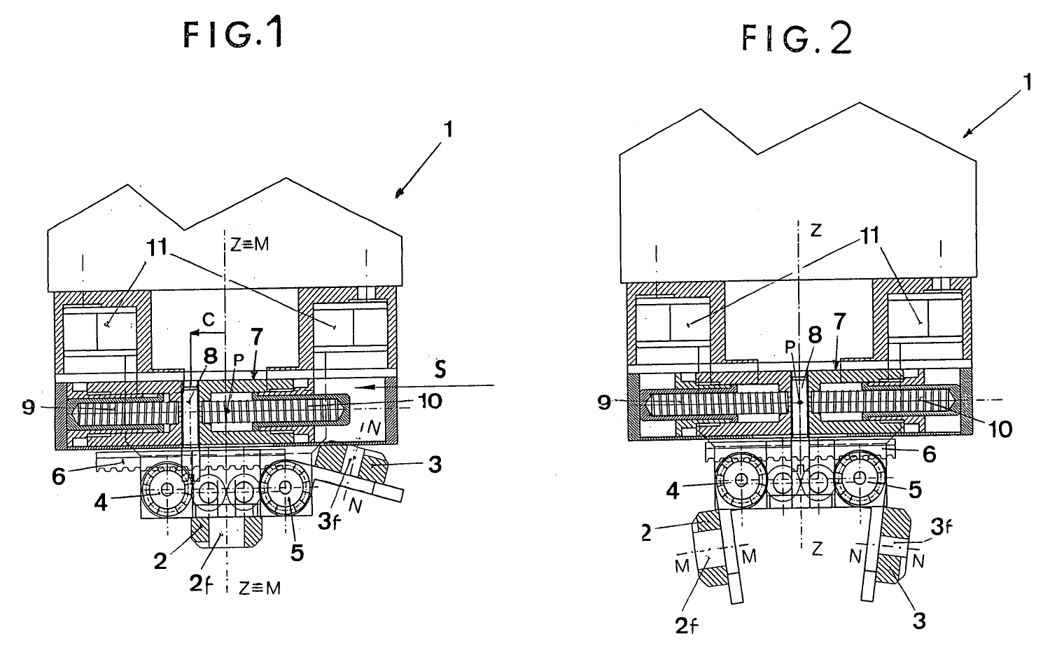

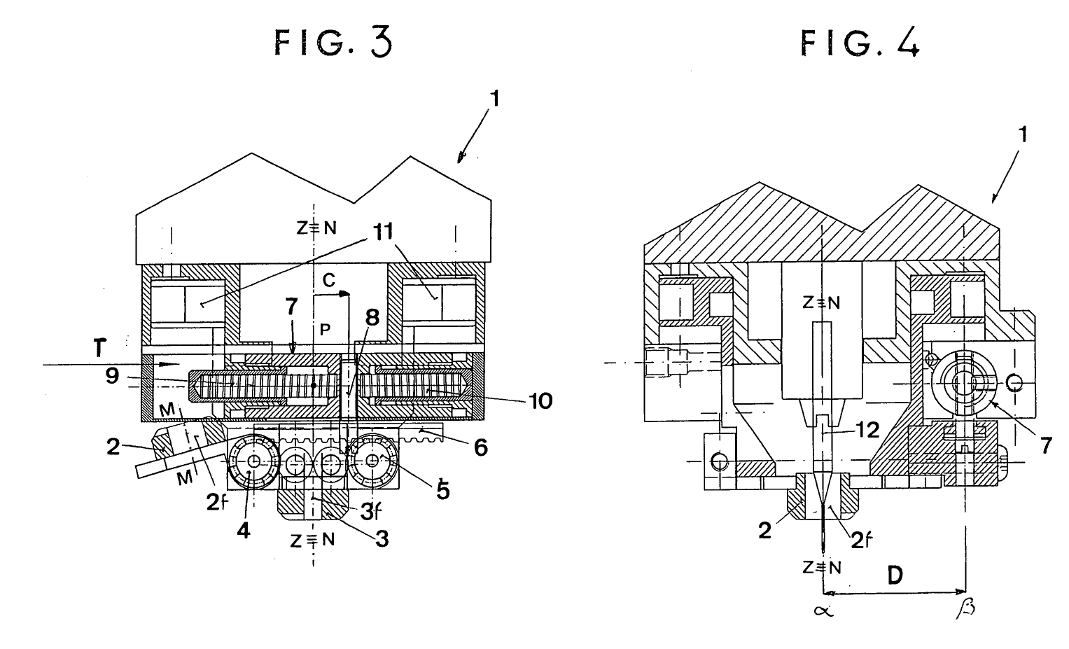

A more detailed description will now be given of a preferred illustrative embodiment of the workpiece clamp of the invention: in the course of this description reference will also be made to the appended drawings, which show:
in FIG. 1 the said illustrative embodiment of the workpiece clamp of the invention in a section taken on parallel vertical planes, in the situation in which one of the two compression rings is in the working position, i.e. with the axis of its hole coinciding with the drilling axis;
in FIG. 2 the same section as in FIG. 1 with the workpiece clamp in the waiting position and neither of the two rings in the working position;
in FIG. 3 the same section as in the previous figures, in the situation in which the compression ring that was in the working position in FIG. 1 has been replaced by the other compression ring;
in FIG. 4 a cross section through the workpiece clamp in the same situation as in FIG. 1, clearly showing the position of the drilling tool relative to the double-acting piston by which the compression ring is moved.

To begin with FIG. 1, this shows that a workpiece clamp 1 according to the invention is fitted with two compression rings 2, 3 each having a hole 2f, 3f for the tool to pass through (the tool being shown only in FIG. 4). These compression rings are connected rigidly, on opposite sides of the drilling axis Z-Z of the tool 12 (see also the said FIG. 4), to two pinions 4, 5 in such a way that they rotate with them about their axes, which are horizontally parallel and perpendicular to the plane of the drawing.

The abovementioned pinions 4, 5 mesh with a horizontal rack 6 connected by a link rod 8 to a double-acting pneumatic piston 7 which can execute a stroke C in both directions S, T (see also FIG. 3 for this) from a central point P situated on the centre plane of the workpiece clamp 1.

The double-acting pneumatic piston 7 (which will be referred to from now on as the “piston”), of a type known per se, is operated by air flows controlled by a system of valves 11, also of known type, in order to cause the rack 6 to execute the said stroke C in both said directions S, T, in such a way as to be synchronized with the machining program.

When machining is not being performed, the workpiece clamp 1, as shown FIG. 2, is in a waiting position, with the piston 7 held in position by two identical springs 9, 10 arranged symmetrically in the position in which the longitudinal axis of the said link rod 8, which projects perpendicularly downwards from it, passes through the said central point P.

In this situation, that is in the situation in which no pneumatic action is being exerted on the piston 7, the two compression rings 2, 3 (which from now on will be termed “rings” for short) are in a symmetrical position in which neither of them interferes with the working area, i.e. in which they are at a convenient distance from the drilling axis Z-Z.

When air is introduced into the piston 7 on the right-hand side in the drawing, as shown in FIG. 1, the rack 6 executes a stroke C in the direction indicated by the arrow S, rotating both the pinions 4, 5 and the rings 2, 3 which are connected to them through the same angle as each other. As the rings are mounted symmetrically, at the end of the stroke C in the said direction S they are positioned as shown, that is one ring 2 has the axis M-M of its hole 2f coincident with the drilling axis Z-Z, and the other ring 3 is moved away to the side so as not to interfere with the machining area.

When the direction of the air flow is reversed, i.e. when acting from left to right on the piston 7 as indicated by the arrow T in FIG. 3, the piston 7, and all the parts whose movement depend on it, move first to the position shown in FIG. 2 and then on to the position in FIG. 3, that is where the ring 3, which in FIG. 1 was away from the working area, has the axis N-N of its hole 3f coincident with the drilling axis Z-Z, and where the other ring 2, which in FIG. 1 was in the working position, has been moved a suitable distance away. By cyclically repeating these operations, synchronized as already described, the two rings can be changed very fast and completely automatically, thus achieving the result sought by the inventor.

Obviously, in order for the workpiece clamp 1 of the invention to be able to work, the axes M-M, N-N of the two rings 2, 3 must lie on a plane which does not interfere with the region of the piston 7 and contains the drilling axis Z-Z. One possible positioning of the parts that is suitable for this purpose is that shown in FIG. 4, which relates to the illustrative example described above. In this figure the vertical plane a passing through the axis of the piston 7 is at a distance D from the plane β which is parallel to it and contains the drilling axis Z-Z, that is the axis of the tool 12.

1. Workpiece clamp (1) for a machine tool that drills at high speeds, provided with two compression rings (2, 3) with holes (2f, 3f) of different diameters for the passage of drilling tools of different diameters, the clamps being characterized in that both of the said compressions rings (2, 3) are mounted on the said workpiece clamp (1), symmetrically and on opposite sides of the drilling axis (Z-Z) and in such a way that they are able to rotate about the horizontal axes of two pinions (4, 5) connected rigidly to the said rings (2, 3), these pinions meshing with a rack (6) that is moved in both directions relative to a central point (P) through a stroke (C) by a double-acting pneumatic piston (7), the form, dimensions and positions of the rings (2, 3) being such that, in response to the rotation of their respective pinions (4, 5), caused by the rack (6) executing the said stroke (C) in one of the two directions, only one, alternately, of the said rings is placed in the working position, with the axis of its hole coincident with the drilling axis (Z-Z), and the other is placed in a laterally displaced position where it does not interfere with the said drilling axis (Z-Z).

2. Workpiece clamp according to claim 1, in which the said double-acting pneumatic piston (7) is connected to the said rack (6) by a link rod (8) extending perpendicularly downwards in a position corresponding to the said central point (P) which marks the start of the said strokes (C) in both directions, two identical and symmetrically aligned springs (9, 10) being connected to the two opposite sides of the said pneumatic piston (7) such that, in the absence of any pneumatic action, they keep the abovementioned link rod (8) in position with its longitudinal axis passing through the abovementioned central point (P).
